(19) United States
(12) Patent Application Publication
(10) Pub. No.: US 2006/0129346 A1
(43) Pub. Date: Jun. 15, 2006

(54) Network system for remotely controlling a tester

(75) Inventor: Kyu-Jeong Lee, Yongin-si (KR)

Correspondence Address: F. CHAU & ASSOCIATES, LLC, 130 WOODBURY ROAD, WOODBURY, NY, 11797, US

(73) Assignee: Samsung Electronics Co., LTD, Suwon-si (KR)

(21) Appl. No.: 11/301,550

(22) Filed: Dec. 13, 2005

(30) Foreign Application Priority Data
Dec. 14, 2004 (KR) 2004-105907

(51) Int. Cl. G01M 19/00

(52) U.S. Cl. 702/122

(57) ABSTRACT

Disclosed is a network system and method for remotely controlling the automatic test equipment (or tester) in a semiconductor testing process. A plurality of clients remotely controls the tester through a server. The server comprises an operating system that is capable of communicating with various user interfaces and platforms. Accordingly, the tester may be remotely controlled, regardless of the particular platform of the client. Further, the tester may be remotely controlled on a web environment, as well as on a local area network linked to multiple workstations. The clients can also receive results of the tester to monitor the testing.

### CROSS-REFERENCE TO RELATED APPLICATIONS

This U.S. non-provisional patent application claims priority under 35 U.S.C. § 119 of Korean Patent Application 2004-105907 filed on Dec. 14, 2004, the entire contents of which are hereby incorporated by reference.

### BACKGROUND OF THE INVENTION

1. Field of the Invention

The present invention relates generally to semiconductor test equipment, and more particularly, to a network system for remotely controlling a tester in a multi-platform structure.

2. Description of the Related Art

A semiconductor test process (e.g., electric die sorting (EDS) process) uses a tester (e.g., automatic test equipment (ATE)), a prober, and a test handler in examining the condition of a semiconductor product.

The tester usually operates under the control of a built-in test program to run a test function for wafers or integrated circuits. The test program examines various characteristics of a semiconductor device. The results of the test program are received by a multiplicity of workstations connected through a network.

As illustrated in FIG. 1, a general tester 4 is connected to a plurality of workstations (or personal computers) 6˜12 through a local network 14. Therefore, the tester 4 can be remotely controlled only in the local network 14 to which the plurality of workstations 6˜12 are linked.

The tester 4 includes a test program for driving and controlling the prober, by which user interface 28 of FIG. 2 is provided to local hosts for multiple users.

As shown in FIG. 2, the workstation 6 driving and controlling the tester 4 includes an operating system 20, and a test application 22 adaptable to the operating system 20 and for examining the condition of a semiconductor device. The operating system 20 includes a driver 26 actuating the tester 4. The user interface 28 exchanges data with the workstations 6˜12. The tester application 22 has a tester control library 24 regulating the driver 26.

The workstations 6˜12 are remotely controllable by a network tool assisted by an operating system (e.g., an operating system of Window or Unix) to drive the tester 4, but they cannot be associated with a multi-platform environment.

In an existing technique for remotely controlling the workstations 6˜12 in the multi-platform environment, the tester 4, which is associated with a specific operating system, accompanies a tool of commercial business with a multi-platform function. However, such a technique is inflexible for a variety of operating systems and increases installation time because of the tool of commercial business.

### SUMMARY OF THE INVENTION

The present invention is directed to a network system having a remotely controllable operating system for a tester.

Embodiments of the present invention can provide a network system having a remotely controllable operating system for a tester, which monitors a test result.

In an aspect of the invention, there is provided a network system testing a semiconductor device, comprising: a network; a tester examining the semiconductor device; a server driving and controlling the tester; and a plurality of clients connected to the server through the network, with the plurality of clients comprising a user interface for accepting user data to remotely control the tester.

In some embodiments, the server comprises an operating system, the operating system comprising an application for enabling the plurality of clients to remotely control the tester.

The plurality of clients comprise client programs remotely controlling the tester through the network and monitoring a test result from the tester.

### BRIEF DESCRIPTION OF THE DRAWINGS

The accompanying drawings are included to provide a further understanding of the invention, and are incorporated in and constitute a part of this specification. The drawings illustrate example embodiments of the present invention and, together with the description, serve to explain principles of the present invention. In the drawings:

FIG. 1 is a block diagram showing a general network system remotely controlling a tester;

FIG. 2 is a block diagram showing a software configuration of the tester shown in FIG. 1;

FIG. 3 is a block diagram illustrating a network system remotely controlling a tester in accordance with an exemplary embodiment of the present invention; and

FIG. 4 is a block diagram showing a software configuration of the tester shown in FIG. 3.

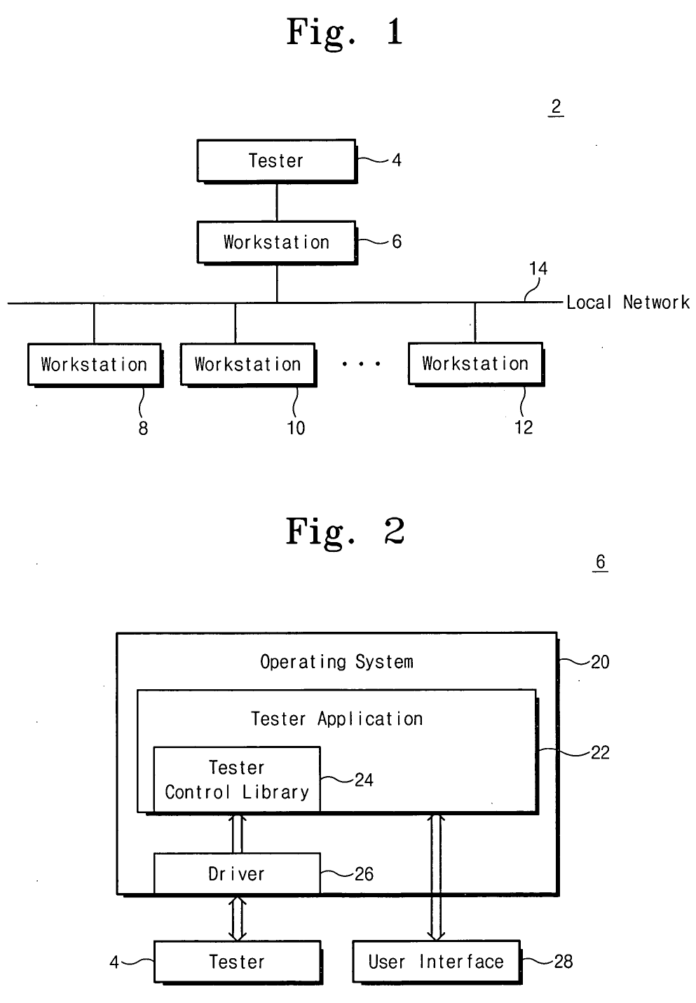

### DETAILED DESCRIPTION OF PREFERRED EMBODIMENTS

Preferred embodiments of the present invention will be described below in more detail with reference to the accompanying drawings. The present invention may, however, be embodied in different forms and should not be constructed as limited to the embodiments set forth herein. Rather, these embodiments are provided so that this disclosure will be thorough and complete, and will fully convey the scope of the invention to those skilled in the art. Like numerals refer to like elements throughout the specification.

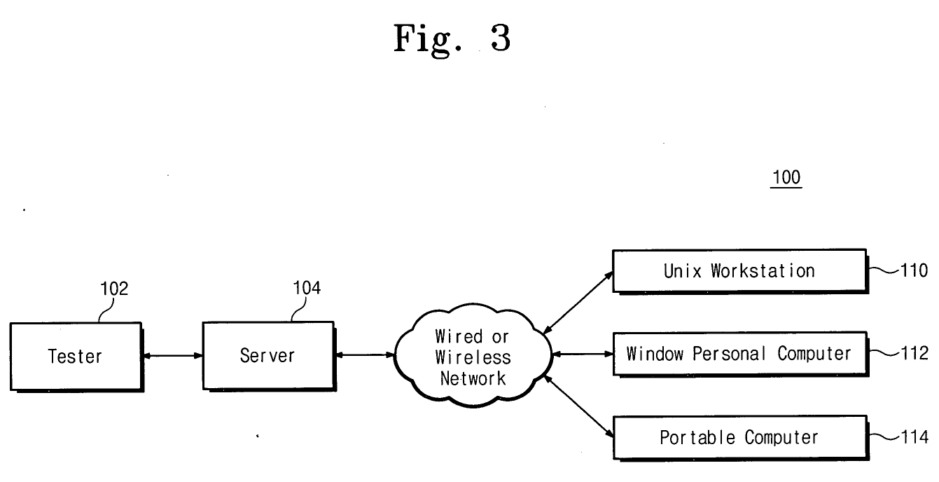

FIG. 3 is a block diagram illustrating a network system remotely controlling a tester in accordance with an exemplary embodiment of the present invention.

Referring to FIG. 3, in the network system 100, a tester 102, a server 104, and a plurality of workstations 110˜114 are connected through a wired or wireless communication network.

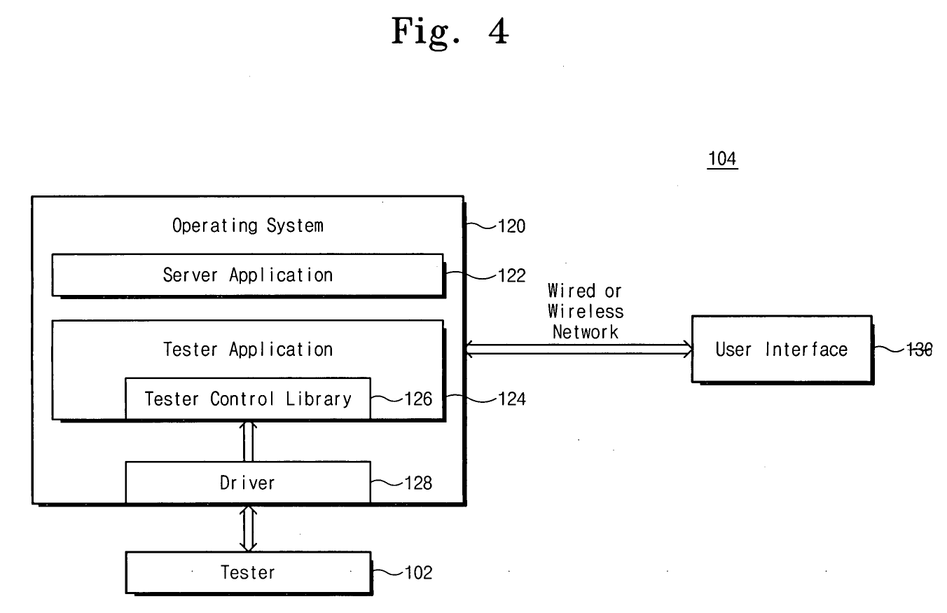

The server 104, as illustrated in FIG. 4, is comprised of an operating system 120 for managing the server function of the tester 102. The operating system 120 is comprised of a server application 122 and a test application 124, both of which are remotely controllable by a network. The server application 122 is configured to communicate among platforms in accordance with the types of operating systems. The server application 122 allows multiple clients 110˜114 having various platforms to be connected through various communication networks (e.g., a local network, a remote network, a radio communication network, and so on).

For example, the server 104 is shared by the multiple users through various communication networks. Under the server 104, each user regards the operating system 120, which contains the tester application 124 and the server application 122 for assisting various software and hardware platforms, as if he exclusively occupies all resources of the system.

The clients 110˜114 are connected to the server 104 through various communication networks, remotely controlling the tester 102 and using data of the user interface 130. The clients 110˜114, although not shown, include client programs (e.g., shell programs) by which the tester 102 is remotely controlled and data resulting from the tester 102 are monitored. For instance, the clients 110˜114 may be a specific workstation 110 for Unix, a personal computer 112 for Window, and a portable computer 114 associated with web access. The clients 110˜114 may be connected through a local or remote network, and may be configured to remotely control the tester 102 irrespective of hardware and software platforms. The clients 110˜114 may be connected to the server 104 by way of a data network such as wired or wireless communication network.

In detail, referring to FIG. 4, the operating system 120 is tester operating system software to operatively control the tester 102. Such software is widely used by many persons such as operators, maintenance engineers, manufacturing engineers, and so forth. Thus, the operating system 120 enables the user interface 130 to acquire data input by a user. The clients 110˜114 communicate the data to the tester 102 through the network. Based on the data, the operating system 120 outputs a test result. Such a configuration enables the tester 102 to be controlled independently of the operating system 120. It also permits the tester 102 to be remotely controlled on a web environment.

The tester operating system 120 adds the application 122 with a server function of the tester 102. The tester operating system 120 remotely controls the tester 102 with a client program (not shown), which receives correspondent user interface data transferred from the user interface 130 to the network through the server 104.

Thus, the server 104 receives the user interface data from the clients 110˜114 through the server application 122. The user interface data is used for remotely controlling the tester 102 through the network, The server 104 drives and controls the tester 102 in correspondence with the user interface data. And then, the server 104 transfers a test result from the tester 102 to its corresponding client, thereby allowing a user to monitor the test result.

As aforementioned, a server for regulating a tester for a semiconductor tester process is described. The server includes an operating system comprised of applications for assisting various networks and operating system platforms. The server allows a client to remotely control and to monitor a test result, regardless of a location of the client and the kind of the operating system. Thus, the server offers convenience in managing and repairing test processing conditions.

Although the present invention has been described in connection with the embodiment of the present invention illustrated in the accompanying drawings, it is not limited thereto. It will be apparent to those skilled in the art that various substitution, modifications and changes may be thereto without departing from the scope and spirit of the invention.

What is claimed is:

1. A network system testing a semiconductor device, comprising:
a network;
a tester examining the semiconductor device;
a server driving and controlling the tester; and
a plurality of clients connected to the server through the network, the plurality of clients comprising a user interface for accepting user data to remotely control the tester and for receiving results of the tester.

2. The network system as set forth in claim 1, wherein the server comprises an operating system, the operating system comprising an application for enabling the plurality of clients to remotely control the tester.

3. The network system as set forth in claim 2, wherein the operating system further comprises:
a driver actuating the tester; and
a library enabling the driver to control the tester.

4. The network system as set forth in claim 1, wherein the plurality of clients comprise client programs remotely controlling the tester through the network and monitoring a test result from the tester.

5. A network system testing a semiconductor device, comprising:
a tester for examining a semiconductor device; and
an operating system for remotely controlling the tester through a network;
wherein the operating system comprises (a) a server application for enabling platform-independent communication through the network, and (b) a driver for controlling the tester in response to user data received through the network.

6. The network system as set forth in claim 5, wherein the operating system further comprises (c) a tester application for enabling the driver to control the tester.

7. The network system as set forth in claim 5, further comprising:
a user interface for acquiring the user data from a user, for transmitting the user data to the operating system, and for receiving test results of the tester from the operating system.

8. The network system as set forth in claim 7, wherein the user interface comprises a plurality of clients operating a plurality of platforms.

9. The network system as set forth in claim 5, wherein the network comprises one of a wired network or a wireless network.

10. The network system as set forth in claim 5, wherein the network comprises an Internet.
